(19) United States
(12) Patent Application Publication
(10) Pub. No.: US 2005/0246089 A1
(43) Pub. Date: Nov. 3, 2005

(54) Method and device for limiting the speed of a vehicle

(76) Inventor: Christian Muehlbauer, Asperg (DE)

Correspondence Address: KENYON & KENYON, ONE BROADWAY, NEW YORK, NY, 10004, US

(21) Appl. No.: 11/105,620

(22) Filed: Apr. 13, 2005

(30) Foreign Application Priority Data
Apr. 30, 2004 (DE) 102004021367.4

(51) Int. Cl. G06F 7/00

(52) U.S. Cl. 701/93

(57) ABSTRACT

A method and a device for limiting the speed of a vehicle increase driving safety under poor visibility or wet roadway conditions in a particularly simple manner. The vehicle speed is limited as a function of the visibility or the roadway condition.

### BACKGROUND INFORMATION

Methods for limiting the speed of a vehicle are already known.

Furthermore, it is known, for example, from German Patent Application No. DE 198 29 162 that an imaging system has an input for a signal from a light switch and/or a speedometer and/or a windshield wiper and/or a thermometer and/or a transmission. This makes it possible to indicate to the driver a number of further speed irregularities. For example, in the case of a speed limit which is only in effect when the roadway is wet, it is possible to indicate this to the driver only when the roadway is actually wet, by analyzing the signal of the windshield wiper. An indication is output only when the windshield wiper is in operation.

### SUMMARY OF THE INVENTION

The method and the device according to the present invention for limiting the speed of a vehicle have the advantage that the vehicle speed is limited as a function of the visibility or the roadway condition. In this way it is possible to automatically limit the vehicle speed as a function of the weather, thereby increasing driving safety and driving comfort. In this way, it is possible to prevent the vehicle from entering a borderline situation too quickly in which the vehicle is no longer controllable by the driver.

It is particularly advantageous when a variable is determined which is characteristic for the visibility or the roadway condition and when the vehicle speed is limited as a function of this variable. This represents a particularly simple implementation of the weather-dependent limit of the vehicle speed which may be carried out with the aid of suitable signal processing of a measuring signal.

It is particularly advantageous when a speed of a windshield wiper is selected as the characteristic variable. In this way, an already available variable may be used for the weather-dependent limit of the vehicle speed which is also particularly significant for the visibility or the roadway condition with regard to wetness and slickness.

The vehicle speed may be limited particularly comfortably if the windshield wiper speed is set as a function of a signal of a precipitation sensor. If the windshield wiper speed is able to be set continuously variably as a function of the precipitation sensor signal, it is possible to limit the vehicle speed in a continuously variable manner as a function of that precipitation sensor signal. This allows a particularly differentiated limit of the vehicle speed as a function of the visibility or the roadway condition, i.e., the weather conditions.

A further advantage arises when the windshield wiper speed is preset using a control element. All vehicles are generally equipped with this feature, so that no additional expense is required for additional components. In this case, the limit of the vehicle speed may be derived from the position of the control element in a particularly simple manner.

A further advantage arises when the vehicle speed is increasingly limited as the visibility decreases or the roadway condition deteriorates. A particularly simple connection for increasing driving safety may be utilized in this way. In the event that the windshield wiper speed is used as the characteristic variable for the visibility or the roadway condition, this may simply occur in that the vehicle speed is increasingly limited as the windshield wiper speed increases.

### BRIEF DESCRIPTION OF THE DRAWINGS

FIG. 1 shows a block diagram of a device according to the present invention for limiting the vehicle speed.

FIG. 2 shows a sequence diagram for explaining the method according to the present invention on the basis of an example.

### DETAILED DESCRIPTION

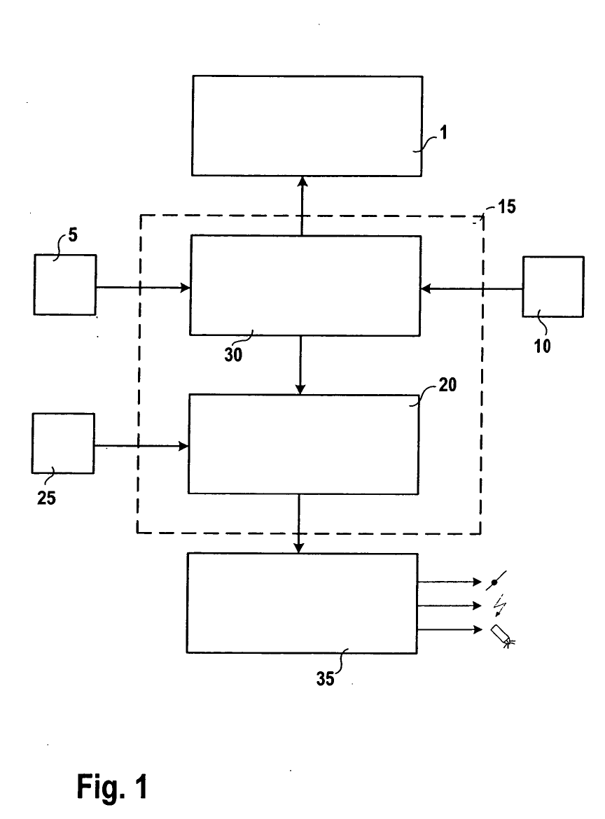

In FIG. 1, reference numeral 15 indicates a device for limiting the speed of a vehicle. This device may be implemented in the form of software and/or hardware in an engine management 35 of the vehicle or may also be situated outside engine management 35 as illustrated in FIG. 1. Device 15 includes a windshield wiper controller 30 which sets the motor of one or multiple windshield wiper(s) 1 for setting a predefined windshield wiper operation. As an example, it should be assumed in the following that a single windshield wiper is operated in this way. The explanations provided in the following analogously apply to the operation of multiple windshield wipers controlled by windshield wiper controller 30 in the described manner via a windshield wiper motor. For the sake of simplicity, reference is made in the following to control of windshield wiper 1 by windshield wiper controller 30. A control element 10 as shown in FIG. 1, in the form of a windshield wiper lever for example, may be provided, allowing the driver of the vehicle to set an intended operation of windshield wiper 1. Control element 10 is connected to windshield wiper controller 30 for this purpose. Different positions of control element 10 result in the fact that windshield wiper controller 30 triggers windshield wiper 1 to operate at different speeds. If, for example, control element 10 is in a first position, windshield wiper 1 is switched off, i.e., windshield wiper controller 30 does not trigger windshield wiper 1. If control element 10 is in a second position, windshield wiper controller 30 triggers an interval operation of windshield wiper 1, windshield wiper 1 moving in intervals at a first speed. In a third position of control element 10, windshield wiper controller 30 triggers a continuous operation of windshield wiper 1 in which it moves back and forth at the first speed. In a fourth position of control element 10, windshield wiper controller 30 triggers a continuous operation of windshield wiper 1 in which it moves back and forth at a second speed. The second speed is greater than the first speed. The wiper intervals in the interval operation in the second position of control element 10 result in an average speed of windshield wiper 1 which is less than the first speed. Described device 15 or windshield wiper controller 30 thus enables operation of windshield wiper 1 at different speeds depending on the position of control element 10. Only discrete speeds may be set. A precipitation sensor 5 may additionally or alternatively be provided which measures the precipitation amount in a manner known to those skilled in the art and, dependent thereon, conveys a signal to windshield wiper controller 30. Windshield wiper controller 30 triggers windshield wiper 1 as a function of the precipitation amount measured by precipitation sensor 5. It may be provided that, depending on the precipitation amount detected by precipitation sensor 5, windshield wiper controller 30 operates windshield wiper 1 in one of the three described operational modes, i.e., either in interval mode or continuously at the first speed or continuously at the second speed. Alternatively, it may be provided that windshield wiper controller 30 triggers windshield wiper 1 to operate at a continuously variable speed as a function of the precipitation amount detected by precipitation sensor 5. Windshield wiper 1 is generally triggered in such a way that the heavier the precipitation amount detected by precipitation sensor 5, the higher the windshield wiper's speed.

According to the present invention, it is provided that windshield wiper controller 30 emits a signal to a limiting unit 20 of device 15 as a function of the position of control element 10 or as a function of the precipitation amount detected by precipitation sensor 5. This signal is characteristic for the set speed of windshield wiper 1 and may be derived from the position of control element 10 or from the precipitation amount detected by precipitation sensor 5. The signal, transmitted from windshield wiper controller 30 to limiting unit 20, represents a limiting value for the speed of the vehicle. This limiting value decreases as the speed of windshield wiper I increases. In this way, given an increasing precipitation amount, which is detected by precipitation sensor 5 and which generally results in a corresponding adjustment of control element 10 by the driver, the speed of windshield wiper 1 is increased and the limiting value for the vehicle speed is decreased, thereby increasing the driving safety. In addition, the actual vehicle speed is supplied to limiting unit 20 by an actual speed sensor 25 which detects the actual vehicle speed. Limiting unit 20 transmits a control signal to engine management 35 as a function of the comparison of the limiting value with the actual vehicle speed. In the event that the detected actual speed is greater than the limiting value, limiting unit 20 prompts engine management 35 to reduce the engine torque, by a predefined increment for example. In the case of a gasoline engine, for example, engine management 35 may change the ignition point, the air supply, and/or the fuel supply in a manner known to those skilled in the art. If the incremental reduction of the engine torque is not sufficient, i.e., the actual speed is not lowered below the limiting value, the described procedure is repeated and the engine torque is once again lowered by the same increment. This procedure is repeated until the actual speed no longer exceeds the limiting value.

In this way, the vehicle speed is limited as a function of the speed of windshield wiper 1. The speed of windshield wiper 1 represents a variable characteristic for the visibility or the roadway condition. The vehicle speed is thus limited as a function of the visibility or the roadway condition. An increasing speed of windshield wiper 1 to points to a decrease in visibility or a deterioration of the roadway condition due to wetness and slickness. Due to the described procedure, the vehicle speed is ultimately increasingly limited as the visibility or deteriorating roadway condition decreases.

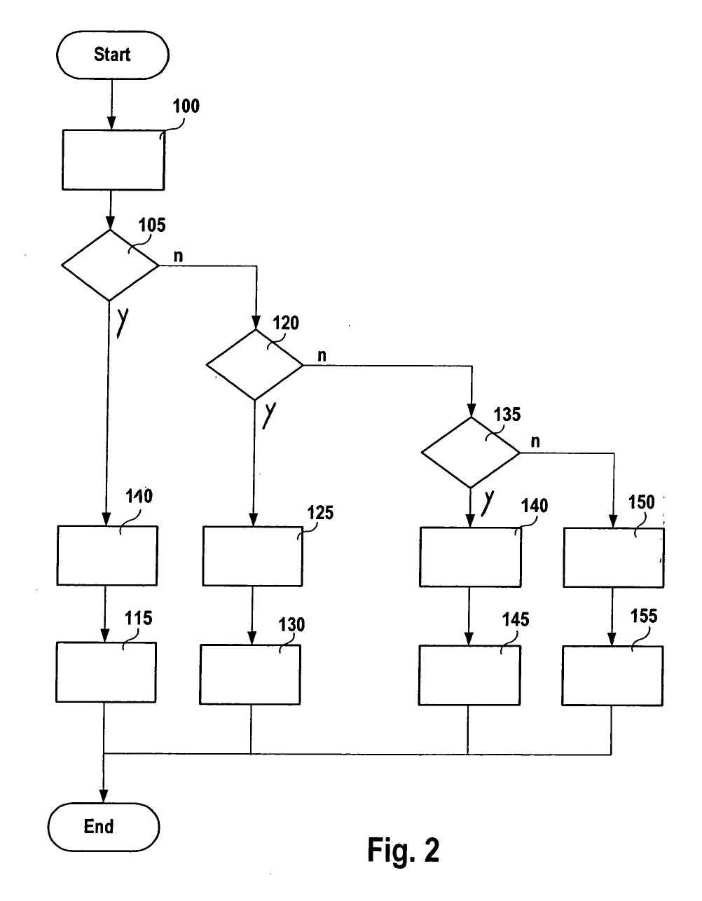

FIG. 2 illustrates a sequence of the method according to the present invention as an example. After the program start, engine management 35 initiates a conversion of a driver's intent, preset on an accelerator pedal of the vehicle, into a corresponding engine torque in a manner known to those skilled in the art. At this point the vehicle travels at an actual speed which is not limited by limiting unit 20. The program subsequently branches to a program point 105. Windshield wiper controller 30 checks at program point 105 whether control element 10 is in its first position. If this is the case, the program branches to a program point 110, otherwise it branches to a program point 120. If windshield wiper 1 is not already switched off, windshield wiper controller 30 initiates a switch off of windshield wiper I at program point 110. The program subsequently branches to a program point 115. At program point 115, windshield wiper controller 30 interrupts transmission of a signal to limiting unit 20, in the event that transmission of such a signal from windshield wiper controller 30 to limiting unit 20 has not been previously interrupted, so that limiting unit 20 does not limit the vehicle speed. The program is subsequently exited. The program may subsequently be restarted and run.

Windshield wiper controller 30 checks at program point 120 whether control element 10 is in its second position. If this is the case, the program branches to a program point 125, otherwise it branches to a program point 135.

At program point 125, windshield wiper controller 30 initiates the interval operation of windshield wiper 1. The program subsequently branches to a program point 130.

At program point 130, windshield wiper controller 30 transmits a signal to limiting unit 20 and, via this signal, specifies for limiting unit 20 a limiting value of, for example, 160 km per hour for the duration of the interval operation. Limiting unit 20 then limits the vehicle speed to this limiting value in the described manner. The program is subsequently exited. The program may subsequently be executed again and, initially at program point 100, the vehicle is operated at the last specified limit of the speed, in this case the limit due to the interval operation of windshield wiper 1 and the exemplary limit to 160 km per hour.

Windshield wiper controller 30 checks at program point 135 whether control element 10 is in its third position. If this is the case, the program branches to a program point 140, otherwise it branches to a program point 150.

At program point 140, windshield wiper controller 30 initiates the continuous operation of windshield wiper 1 at the first speed.

The program subsequently branches to a program point 145.

At program point 145, windshield wiper controller 30 transmits to limiting unit 20 a signal carrying a limiting value for the vehicle speed which is less than the limiting value at program point 130 and is 130 km per hour, for example. Thereupon, limiting unit 20 initiates in the described manner a limit of the vehicle speed to the limiting value specified at program point 145, in this example 130 km per hour. The signal carrying this limiting value is transmitted from windshield wiper controller 30 to limiting unit 20 as long as control element 10 is in its third position. The program is subsequently exited. The program may subsequently be executed again and, at program point 100, the vehicle is initially operated at the limit of the vehicle speed specified during the previous program run at program point 145.

At program point 150, windshield wiper controller 30 initiates the continuous operation of windshield wiper 1 at the second speed, since in this case control element 10 may only be in its fourth position. The program subsequently branches to a program point 155. At program point 155, windshield wiper controller 30 initiates transmission of a signal to limiting unit 20 carrying a limiting value which is less than the limiting value specified at program point 145 and is 100 km per hour, for example. Limiting unit 20 then limits the vehicle speed in the described manner to this limiting value of, in this example, 100 km per hour as long as control element 10 is in its fourth position. The program is subsequently exited. The program may subsequently be re-run and, at program point 100, the vehicle is initially operated at the limiting value for limiting the vehicle speed specified at program point 155 during the previous program run.

The sequence diagram in FIG. 2 was described based on the position of control element 10 presettable by the driver. Alternatively, the sequence according to FIG. 2 may also be run as a function of the signal of precipitation sensor 5. The precipitation amount, detected by precipitation sensor 5, may be subdivided into four areas. Precipitation amounts between the value zero and a first threshold value correspond to the position of control element 10 in its first position so that, at such a precipitation amount, the program branches from program point 105 to program point 110 and windshield wiper 1 is switched off. Precipitation amounts between the first threshold value and a second threshold value, which is greater than the first threshold value, is interpreted as corresponding to the second position of control element 10 so that, in this case, the program branches from program point 120 to program point 125 and windshield wiper 1 is operated in interval operation. Precipitation amounts between the second threshold value and a third threshold value, which is greater than the second threshold value, are treated as control element 10 in its third position so that, in this case, the program branches from program point 135 to program point 140 and windshield wiper controller 30 causes windshield wiper 1 to operate continuously at the first speed. For precipitation amounts greater than the third threshold value, the program branches from program point 135 to program point 150 and, corresponding to control element 10 being in its fourth position, windshield wiper controller 30 causes windshield wiper 1 to operate continuously at the second speed.

In the event of a continuously variable setting of the speed of windshield wiper 1 by windshield wiper controller 30 as a function of the precipitation amount detected by precipitation sensor 5, a limiting value may be transmitted from windshield wiper controller 30 to limiting unit 20 correspondingly in a continuously variable manner. In this way, the vehicle speed may be specified in a particularly differentiated manner as a function of the speed of windshield wiper 1, or as a function of the precipitation amount, or as a function of the visibility or the roadway condition.

The position of control element 10 may thus be interpreted as the precipitation amount or as the condition of the visibility or the roadway.

In the event of an absent specification of a limiting value for the vehicle speed on the part of windshield wiper controller 30, the vehicle speed may be limited, in a manner known to those skilled in the art, to a permanently pre-set value, 250 km per hour, for example.

1. A method for limiting a speed of a vehicle, comprising:
limiting the vehicle speed as a function of at least one of a visibility and a roadway condition.

2. The method according to claim 1, further comprising determining a variable which is characteristic for one of the visibility and the roadway condition, and wherein the vehicle speed is limited as a further function of the variable.

3. The method according to claim 2, wherein the characteristic variable is a speed of a windshield wiper.

4. The method according to claim 3, further comprising setting the speed of the windshield wiper as a function of a signal of a precipitation sensor.

5. The method according to claim 4, wherein the vehicle speed is limited as a further function of the signal of the precipitation sensor.

6. The method according to claim 3, further comprising presetting the speed of the windshield wiper on a control element.

7. The method according to claim 6, wherein the vehicle speed is limited as a further function of a position of the control element.

8. The method according to claim 1, wherein the vehicle speed is more sharply limited as at least one of (a) the visibility decreases and (b) the roadway condition deteriorates.

9. The method according to claim 8, wherein the vehicle speed is increasingly limited as a speed of a windshield wiper increases.

10. The method according to claim 1, wherein the vehicle speed is limited as a function of the visibility.

11. The method according to claim 1, wherein the vehicle speed is limited as a function of the roadway condition.

12. A device for limiting a speed of a vehicle, comprising:
means for limiting the vehicle speed as a function of at least one of a visibility and a roadway condition.

13. The device according to claim 12, wherein the vehicle speed is limited as a function of the visibility.

14. The device according to claim 12, wherein the vehicle speed is limited as a function of the roadway condition.
